(19) United States
(12) Patent Application Publication
(10) Pub. No.: US 2008/0117163 A1
(43) Pub. Date: May 22, 2008

(54) Liquid crystal display having photoelectric conversion unit

(75) Inventors: Wei Zhou, Shenzhen (CN); Qian Kang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/986,382

(22) Filed: Nov. 21, 2007

(30) Foreign Application Priority Data
Nov. 21, 2006 (TW) 95142995

(51) Int. Cl. G09G 3/36

(52) U.S. Cl. 345/102

(57) ABSTRACT

An exemplary liquid crystal display includes a backlight module and a liquid crystal panel provided adjacent to the backlight module. The liquid crystal panel includes a display module, a gate driving circuit, a power supply input configured for providing a first voltage obtained from a power supply, a photoelectric conversion unit, and a comparator. The gate driving circuit is configured for scanning the display module. The photoelectric conversion unit is configured for receiving light from the backlight module and converting the light into a second voltage. The comparator is configured for comparing the first voltage and the second voltage, and providing the greater one of the first and second voltages to the gate driving circuit.

### FIELD OF THE INVENTION

The present invention relates liquid crystal displays (LCDs), and particularly to a liquid crystal display including a photoelectric conversion unit for converting light beams into a voltage.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions. An LCD generally includes a liquid crystal panel, a driving circuit for driving the liquid crystal panel, and a backlight module for illuminating the liquid crystal panel.

Referring to FIG. 3, a typical liquid crystal display 1 includes a liquid crystal panel 10 and a backlight module 11 adjacent to the liquid crystal panel 10. The backlight module 11 is configured to illuminate the liquid crystal panel 10.

Referring also to FIG. 4, the liquid crystal panel 10 includes a display module 110, a gate driving circuit 100, a data driving circuit 120, and a flexible printed circuit (FPC) 130. The gate driving circuit 100 includes a booster circuit 150 and a control circuit 160. The booster circuit 150 includes an analog voltage input 151 and a plurality of analog voltage outputs 152. The plurality of analog voltage outputs 152 are connected to the control circuit 160. The FPC 130 is connected with the analog voltage input 151 of the booster circuit 150, and is configured to provide analog voltages to the booster circuit 150. The booster circuit 150 boosts the received analog voltages, and provides boosted analog voltages to the control circuit 160 through the analog voltage outputs 152. The control circuit 160 provides a plurality of scanning signals to the display module 110. At the same time, the data driving circuit 120 provides a plurality of data signals to the display module 110. Thus, the display module 110 displays images.

However, when the LCD 1 works, the FPC 130 must continuously provide voltages to the gate driving circuit 100. Therefore, the LCD 1 has high electrical power consumption.

What is needed, therefore, is a new liquid crystal display that can overcome the above-described deficiencies.

### SUMMARY

In one preferred embodiment, a liquid crystal display includes a backlight module and a liquid crystal panel provided adjacent to the backlight module. The liquid crystal panel includes a display module, a gate driving circuit, a power supply input configured for providing a first voltage obtained from a power supply, a photoelectric conversion unit, and a comparator. The gate driving circuit is configured for scanning the display module. The photoelectric conversion unit is configured for receiving light from the backlight module and converting the light into a second voltage. The comparator is configured for comparing the first voltage and the second voltage, and providing the greater one of the first and second voltages to the gate driving circuit.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, side-on view of a liquid crystal display according to an exemplary embodiment of the present invention, the liquid crystal display including a liquid crystal panel and a backlight module.

FIG. 2 is essentially an abbreviated circuit diagram of the liquid crystal panel of FIG. 1.

FIG. 3 is an exploded, side-on view of a conventional liquid crystal display, the liquid crystal display including a liquid crystal panel and a backlight module.

FIG. 4 is essentially an abbreviated circuit diagram of the liquid crystal panel of FIG. 3.

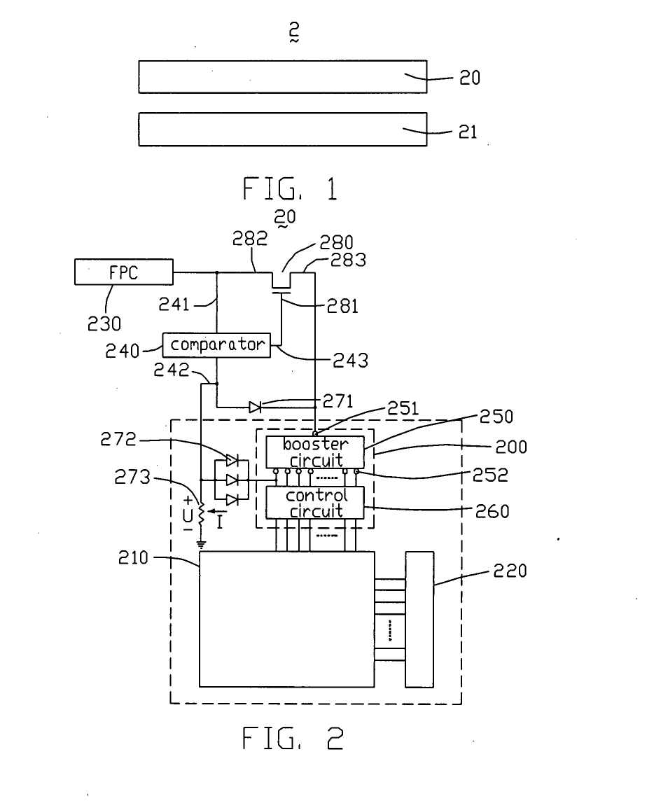

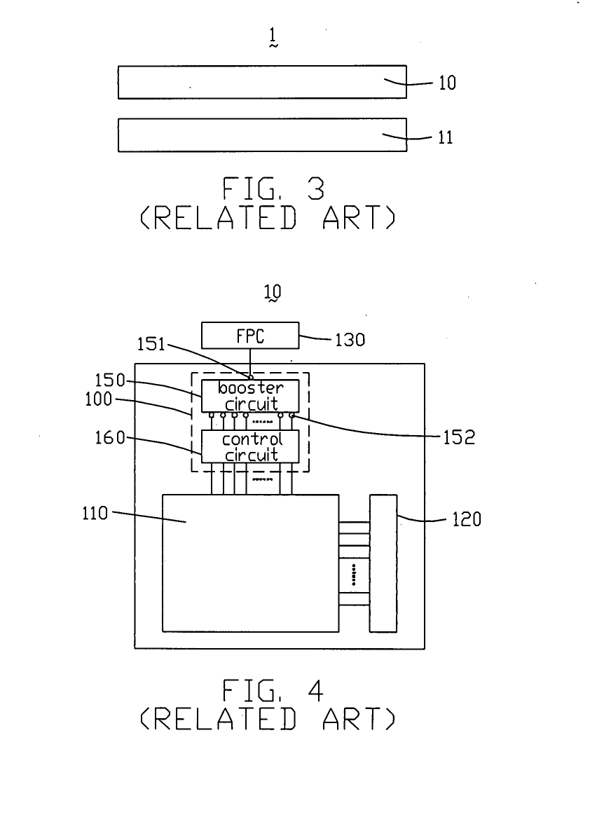

### DETAILED DESCRIPTION OF PREFERRED EMBODIMENTS

Referring to FIG. 1, a liquid crystal display 2 according to an exemplary embodiment of the present invention is shown. The liquid crystal display 2 includes a liquid crystal panel 20, and a backlight module 21 adjacent to the liquid crystal panel 20. The backlight module 21 is configured to illuminate the liquid crystal panel 20.

Referring also to FIG. 2, the liquid crystal panel 20 includes a display module 210, a gate driving circuit 200, a data driving circuit 220, an FPC 230, a comparator 240, a protecting diode 271, a plurality of photodiodes 272, a reactance 273, and a transistor 280. The data driving circuit 220 is configured to provide data signals to the display module 210. The FPC 230 is configured to provide an analog voltage obtained from a power supply (not shown). The photodiodes 272 are connected with one another in parallel.

The gate driving circuit 200 includes a booster circuit 250 and a control circuit 260. The control circuit 260 is configured to provide a plurality of scanning signals to the display module 210. The booster circuit 250 includes an analog voltage input 251 and a plurality of analog voltage outputs 252. The plurality of analog voltage outputs 252 are connected to the control circuit 260. One of the analog voltage outputs 252 is further connected to the analog voltage input 251 via the cathodes and anodes of the photodiodes 272 and the anode and cathode of the protecting diode 271, and still further to ground via the cathodes and anodes of the photodiodes 272 and the reactance 273.

The comparator 240 includes a first input 241, a second input 242, and an output 243. The first input 241 is connected to the FPC 230. The second input 242 is connected to the anodes of the photodiodes 272. The output 243 is connected to a gate electrode 281 of the transistor 280. The transistor 280 can be an n-channel field effect transistor. A source electrode 282 of the transistor 280 is connected to the FPC 230, and a drain electrode 283 of the transistor 280 is connected to the analog voltage input 251 of the booster circuit 250.

The reactance 273 can be a resistor, a capacitor, or an inductor.

When the LCD 2 starts to display, the FPC 230 provides an analog voltage to the first input 241 of the comparator 240. At this moment, because the booster circuit 250 does not yet output any voltage, the photodiodes 272 are not set to work, and no inverse current is generated. Therefore, a voltage of the second input 242 of the comparator 240 is equal to zero. The comparator 240 provides a high voltage to the gate electrode 281 of the transistor such that the transistor 280 is switched on. The FPC 230 provides an analog voltage to the analog voltage input 251 of the booster circuit 250 via the source and drain electrodes 282, 283 of the activated transistor 280. The analog voltage outputs 252 output a plurality of boosted analog voltages to the control circuit 260, and the analog voltage output 252 connected to the photodiodes 272 further outputs a boosted analog voltage to the cathodes of the photodiodes 272 such that the photodiodes 272 work in a reverse bias state.

After light beams are emitted from the backlight module 21, part of the light beams shine on the photodiodes 272, thereby generating an inverse current I in the photodiodes 272. Thus, a voltage U is generated between the two terminals of the reactance 273, and the voltage U is applied to the second input 242 of the comparator 240. If the voltage U becomes greater than the analog voltage provided by the FPC 230, the comparator 240 outputs a low voltage to switch off the transistor 280. Thus, the connection between the FPC 230 and the analog voltage input 251 of the booster circuit 250 of the gate driving circuit 200 is shut off. At the same time, the voltage U is provided to the first analog voltage input 251 of the booster circuit 250 for powering the gate driving circuit 200.

If the voltage U becomes less than the analog voltage provided by the FPC 230, the comparator 240 outputs a high voltage to switch on the transistor 280. Thus, the FPC 230 starts to provide the analog voltage to the gate driving circuit 200 again. Overall, the comparator 240 compares the voltage U provided by the photodiodes 272 with the analog voltage provided by the FPC 230, and selects the greater voltage to power the gate driving circuit 200. Therefore, the electricity consumption of the LCD 2 is reduced.

Further or alternative embodiments may include the following. In one example, the transistor 280 can be another kind of switch element, such as a negative-positive-negative (NPN) type bipolar transistor.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display comprising:
a backlight module; and
a liquid crystal panel provided adjacent to the backlight module, the liquid crystal panel comprising:
a display module;
a gate driving circuit configured for scanning the display module;
a power supply input configured for providing a first voltage obtained from a power supply;
a photoelectric conversion unit configured for receiving light from the backlight module and converting the light into a second voltage; and
a comparator configured for comparing the first voltage and the second voltage, and providing the greater one of the first and second voltages to the gate driving circuit.

2. The liquid crystal display as claimed in claim 1, wherein the photoelectric conversion unit comprises a photodiode, the photodiode being configured for receiving the light from the backlight module and converting the light into current.

3. The liquid crystal display as claimed in claim 2, wherein the photoelectric conversion unit further comprises a reactance, the reactance being configured for converting the current into the second voltage.

4. The liquid crystal display as claimed in claim 3, wherein the reactance is one of a resistor, a capacitor, and an inductor.

5. The liquid crystal display as claimed in claim 3, wherein the gate driving circuit comprises a booster circuit and a control circuit, the booster circuit comprising an analog voltage input and a plurality of analog voltage outputs, the analog voltage outputs being connected to the control circuit, the control circuit being configured for providing scanning signals to the display module.

6. The liquid crystal display as claimed in claim 5, wherein the liquid crystal panel further comprises a switch member, and the comparator comprises a first input connected to the power supply, a second input connected to the photoelectric conversion unit, and an output connected to the analog voltage input of the booster circuit via the switch member.

7. The liquid crystal display as claimed in claim 6, wherein a cathode of the photodiode is connected to one of the analog voltage outputs of the booster circuit, and an anode of the photodiode is connected to the second input of the comparator, and further to ground via the reactance.

8. The liquid crystal display as claimed in claim 6, wherein the switch member is an n-channel field-effect transistor, a gate electrode of the transistor being connected to the output of the comparator, a source electrode of the transistor being connected to the power supply, and a drain electrode of the transistor being connected to the analog voltage input of the booster circuit.

9. The liquid crystal display as claimed in claim 7, wherein the liquid crystal panel further comprises a protecting diode, an anode of the protecting diode being connected to the second input of the comparator, a cathode of the protecting diode being connected to the analog voltage input of the booster circuit.

10. The liquid crystal display, as claimed in claim 1, further comprising a flexible printed circuit, wherein the power supply input is comprised in the flexible printed circuit.

11. A liquid crystal display comprising:
a backlight module; and
a liquid crystal panel provided adjacent to the backlight module, the liquid crystal panel comprising:
a display module;
a gate driving circuit configured for scanning the display module;
a power supply input configured for providing a first voltage obtained from a power source; and
a power supply unit configured for receiving light beams from the backlight module and converting the light beams into a second voltage;
wherein the greater one of the first and second voltages is provided to the gate driving circuit.

12. The liquid crystal display as claimed in claim 11, further comprising a comparator, the comparator being configured for comparing the first voltage and the second voltage and providing the greater one of the first and second voltages to the gate driving circuit.

13. The liquid crystal display as claimed in claim 12, wherein the second power supply is a photodiode conversion unit, the photoelectric conversion unit comprising a photodiode and a reactance, the photodiode being configured for receiving the light from the backlight module and converting the light into current, the reactance being configured for converting the current into the second voltage.

14. The liquid crystal display as claimed in claim 13, wherein the reactance is one of a resistor, a capacitor, and an inductor.

15. The liquid crystal display as claimed in claim 13, wherein the gate driving circuit comprises a booster circuit and a control circuit, the booster circuit comprising an analog voltage input and a plurality of analog voltage outputs, the analog voltage outputs being connected to the control circuit, the control circuit being configured for providing scanning signals to the display module.

16. The liquid crystal display as claimed in claim 15, wherein the liquid crystal panel further comprises a switch member, and the comparator comprises a first input connected to the power supply, a second input connected to the photoelectric conversion unit, and an output connected to the analog voltage input of the booster circuit via the switch member.

17. The liquid crystal display as claimed in claim 16, wherein a cathode of the photodiode is connected to one of the analog voltage outputs of the booster circuit, and an anode of the photodiode is connected to the second input of the comparator, and further to ground via the reactance.

18. The liquid crystal display as claimed in claim 16, wherein the switch member is an n-channel field-effect transistor, a gate electrode of the transistor being connected to the output of the comparator, a source electrode of the transistor being connected to the power supply, and a drain electrode of the transistor being connected to the analog voltage input of the booster circuit.

19. The liquid crystal display as claimed in claim 17, wherein the liquid crystal panel further comprises a protecting diode, an anode of the protecting diode being connected to the second input of the comparator, a cathode of the protecting diode being connected to the analog voltage input of the booster circuit.

20. The liquid crystal display as claimed in claim 1, further comprising a flexible printed circuit, wherein the power supply input is comprised in the flexible printed circuit.
